(19) United States
(12) Patent Application Publication
(10) Pub. No.: US 2025/0002193 A1
(43) Pub. Date: Jan. 2, 2025

(54) Separating Device

(71) Applicant: kocher-plastik Maschinenbau GmbH, Sulzbach-Laufen (DE)

(72) Inventors: Martin Burgherr, Aarau (CH); Philip Irtenkauf, Gaildorf (DE); Sebastian Fischer, Triengen (CH); Pietro De Tommaso, Rothrist (CH)

(73) Assignee: kocher-plastik Maschinenbau GmbH, Sulzbach-Laufen (DE)

(21) Appl. No.: 18/712,477

(22) PCT Filed: Dec. 2, 2022
(86) PCT No.: PCT/EP2022/084194

§ 371 Date: May 22, 2024

(30) Foreign Application Priority Data
Jan. 12, 2022 (DE) 10 2022 000 100.4

(51) Int. Cl. B65B 43/46; B65B 3/00; B65B 55/02

(52) U.S. Cl. CPC B65B 43/46; B65B 3/00; B65B 55/02

(57) ABSTRACT

A separating device for separating individual or multiple container products from a frame structure which is made from plastic material and comprises at least one side strip which can be moved along a transport direction by means of a conveying device which acts on individual positioning aids of the side strip, wherein at least one positioning aid is fixed in a clamping manner by means of a centring device before the separation is carried out.

### CROSS-REFERENCE TO RELATED APPLICATIONS

This application claims priority to German Patent Application No. DE 10 2022 000 100.4, filed on Jan. 12, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a separating device for separating individual or multiple container products from a frame structure which is made from plastics material and comprises at least one side strip which can be moved along a transport direction by means of a conveying device which acts on individual positioning aids of the side strip. The disclosure also relates to a positioning device and a method for operating such devices.

DE 10 2018 009 238 A1 describes a device for preparing plastic containers for putting into use, wherein the containers are formed in container blocks side by side along separating lines with respect to one another, along which the individual containers can be separated from one another for use and along which individual cutting blades can at least partially be movably guided, the respective cutting blade being arranged on a carriage and guided such that it can be displaced to and from between a usage position and a non-usage position, and wherein, in the usage position, the respective cutter blade moves along the respective assignable separating line by means of a pivoting apparatus and, lowered in its non-usage position, it is at a distance from the containers to be separated from one another. In this case it is provided that the container blocks, forming a continuous block chain in one plane and, in the usage position of the cutter blades, extending with their separating lines along the same plane, are guided in a stand apparatus of the device, in which a hold-down device is guided such that it can move longitudinally up and down transversely with respect to the displacement motion of the block chain, which, when lowered into its holding position exerts a force on the block chain that counteracts the contact or engagement force of the cutter blades. By securing the position of the container blocks during the cutting operation by means of the hold-down device, the pre-separation cut can be performed precisely with the desired cutting length and position.

With regard to the exact positioning of the frame structure with the container received in each case inside the separating device, in order to ensure precise, accurate cutting and separation of the containers from the frame structure with minimal application of energy, the known solutions leave much to be desired. In all cases, in particular with small-volume containers, as are typically used for applying eye drops, imprecise punching or damage to the filled containers can readily occur as part of the separation operation. As a result, under some circumstances, not only does one individual container become unusable, but rather the entire ampoule block in which the containers are located is rendered substantially unusable for use.

This is caused, amongst other things, by so-called processing shrinkage, which has long been a known phenomenon in plastics technology. This time and temperature-dependent change in volume of the plastics material that comes about immediately after moulding differs significantly depending on the polymer used. In connection with the partially crystalline plastics material preferably used for the blow/fill/seal process, such as PP or LDPE or HDPE, shrinkage comes about due to increasing crystallisation, which causes local increases in density and thus volume reductions. In turn, these inevitably lead to dimensional changes in the plastics product and thus inevitably to inaccurate positional relationships of the container belt inside the separating device with the separating tools, which leads to the aforementioned risks/disadvantages.

To date, it has been possible to counteract this problem by a non-mechanical positioning of the container belt in the separating device by a special optical detection unit, preferably using a camera or a laser scanner. DE 10 2010 011 207 A1 accordingly discloses a device and associated method for cutting interconnected composite plastics products in the composite for the medical field including the following steps:
provision of interconnected composite plastics products,
determination of position data for the interconnected composite plastics products by an optical detection unit and calculation of a cutting pattern by a data processing unit,
controlling a laser by means of at least one laser control system, consisting of a controllable focusing device, a controllable deflection device and beam shaping, wherein the position and intensity of the focal point of the laser is controlled as a function of the determined position data, and
cutting the interconnected composite plastics products by laser according to the calculated cutting pattern.

However, the laser technology used here is technically complex and cost-intensive and the associated optical equipment is also fundamentally prone to contamination. In practice, therefore, it has been shown that such optical systems are more prone to faults than a mechanical system in any event.

### SUMMARY

A need exists to provide more reliable operations to separate containers from an associated frame structure during production so as to reduce technical risks and/or rejection rate.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example separating device in its entirety, partly in section, partly as a side view;

FIG. 2 is a plan view of the separating device of FIG. 1;

FIG. 3 is a sectional view through an example centring device used in FIGS. 1 and 2;

FIGS. 4 and 5 show the centring device according to FIG. 3 in the actuated state and non-actuated state respectively; and

FIG. 6 is an enlarged perspective view of an example positioning aid in the form of a control cam.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, at least one positioning aid is fixed in a clamping manner by means of a centring device before separation is carried out by means of the separating tools. Due to this, exact positioning of the frame structure having the containers, made from plastics material, received inside the separating device in each case is achieved, wherein, due to centring via the positioning aid on the side strip of the frame structure, the provided cutting or separating lines are positioned exactly opposite the separating tools of the separating device such that a separation operation is able to take place exactly along these provided separating or cutting lines without the possibility of cutting errors with potential damage to the container products. As such, there is no longer any significant wastage when carrying out the cutting operation, which can thus take place more reliably and with less energy due to the precise separation geometries. As the separation operation can be carried out precisely along predefinable cutting lines, tilting of the separation or cutting tools can be avoided under all circumstances so as to promote low-wear, long-lasting operation with the separating device.

In some embodiments of the separating device, it is provided that the respective positioning aid consists of a fixing cam, which, as an integral part of the side strip, protrudes over said strip and that the centring device acts on said fixing cam by means of movable clamping parts in front of and behind the fixing cam to be fixed, as viewed in the transport direction, by applying a clamping force. As the clamping parts of the centring device fix the respective fixing cam between said parts in a force-locking manner like a pair of tongs, the connection between the centring device and the fixing cam is established without any clearance in at least two directions, which promotes precise cutting line guidance.

In some embodiments of the separating device, it is provided that the clamping parts of the centring device consist of two clamping jaws, which are controlled by an actuating device and assume a predefinable distance from one another in an open position, said distance reducing in a clamping position until a clamping gap is reached in which the assignable positioning aid is received. Particularly when the feed path of the clamping parts, viewed in the vertical direction, towards the side strip increases, the lower side of the clamping parts comes into guiding contact with the adjacent opposite upper side of the side strip with the respective positioning aid such that, controlled in this manner, against the effect of the actuating device, the closing operation for the clamping parts takes place automatically up to clamping contact thereof on the positioning aid. In the opposite lifting movement, the actuating device used between the tong-like clamping parts ensures that the clamping parts return to their starting position; a starting position from which a centring operation is then in turn carried out again, passing the side strip along with the fixing cams arranged thereon along a predefinable distance, for the purpose of carrying out a precise separation.

For example, in this case, the clamping jaws are pivotally mounted in pairs in a seat in the centring device and a pressure piece arranged between the clamping jaws acts as an actuating device, said pressure piece being able to be brought into an active position to maintain the open position of the clamping jaws by means of an energy accumulator, for example in the form of a compression spring. As such, it is possible to reset the centring device into a starting position in a particularly energy-saving manner using a simple compression spring without requiring an independent drive unit, such as an electric motor or similar, for this purpose.

In some embodiments, it is provided that the pair of clamping jaws comprises a centring part at each of its opposite free end faces, said centring part coming into linear contact in the clamping position with the positioning aid at its bottom transition to the side strip. Thanks to the linear contact between the positioning aid and the clamping parts, there is no overprovision of redundant parts during the centring operation and thus exact positioning of the side strip with respect to the centring device and the punching tool with respect to the container products to be punched out.

For example, it is provided that the centring device can be positioned, by means of a position adjustment, particularly in the form of a height adjustment, for example using an operating cylinder or another actuator, in relation to frame parts of the separating device opposite the side strip with its positioning aids. In this manner, the centring device can be positioned opposite the side strip of the frame structure in quick succession.

In some embodiments of the separating device, it is provided that the conveying device comprises a pivotable pawl arrangement, which, when in a pick-up position in contact with a positioning aid of the side strip, picks up said side strip in the transport direction by means of an actuator and then can be returned to a starting position to pick up a next positioning aid in the row after moving over said positioning aid back into the pick-up position. The pivotable pawl can be moved back and forth by means of a linear carriage drive, wherein, when the linear carriage makes a backwards movement, the pivotable pawl loosely moves over the positioning aid on the side strip such that it then drops into the pick-up position in which, when the carriage moves forwards, the pawl moved in the feed direction carries the positioning aid with which it is in contact over a predefined distance in the direction of the next centring device. In this manner, pre-positioning is possible by means of the conveying device with the pawl arrangement, and precision positioning of the frame structure via the positioning aids on the side strip is possible by means of the centring device. The distance between pre-positioning and precision positioning must, however, always be such that, during feed operation of the pawl arrangement, the moved positioning aid or conveying cam, respectively, passes into the access range of the clamping jaws of the centring device for actual centring.

In some embodiments, a positioning device is provided, with which, by means of a centring device, individual movable positioning aids of a frame structure can be fixed in a clamping manner between parts of this centring device in a predefinable position. In this manner, the positioning device serves in very general terms to process a frame structure made from plastics material, which for example comprises at least one side strip in addition to the positioning aids for the purpose of moving the frame structure along a predefined transport direction by means of a conveying device. The aforementioned processing of the frame structure may in this case for example consist of separating, printing, inspecting, marking, labelling, measuring, disinfecting and/or applying a defined breaking point or a combination of these processing operations.

The disclosure also relates to a method for operating a device for the aforementioned processing of a frame structure, which comprises at least one container, for example a printing device, an inspection device, a marking device, a measuring device, a disinfection or sterilisation device, particularly a separating device, as described above, in particular including a positioning device, wherein, in a two-stage conveying and positioning operation along a transport direction by means of a conveying device, pre-positioning takes place by feeding a frame structure and a comparatively more accurate precision positioning operation takes place by means of a centring device.

The solution according to the teachings herein is illustrated in greater detail below with the aid of an embodiment with reference to the drawings, which are in outline and not to scale. Specific references to components, process steps, and other elements are not intended to be limiting. Further, it is understood that like parts bear the same or similar reference numerals when referring to alternate FIGS.

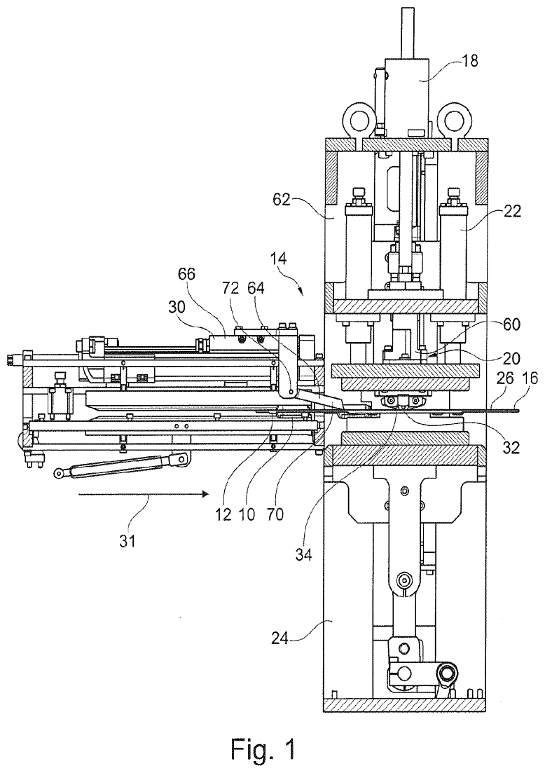

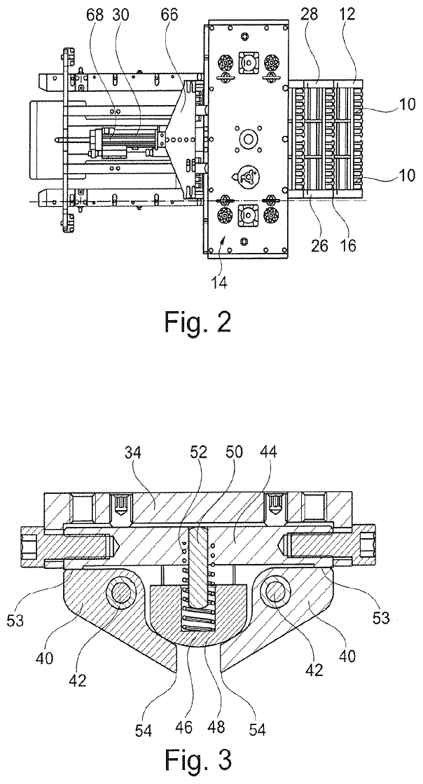

FIG. 1 shows a side view of the main components of a separating device for separating individual container products 10 from a frame structure 12 (see FIG. 2), which consists of a plastics material such as polypropylene (PP) or polyethylene (LDPE or HDPE), for example. Of course, other suitable plastics materials may also be used in this case. The container products may be empty or at least partially filled. The separating device according to FIG. 1 comprises a punching device 14, which separates the respective container product 10 from a waste frame 16. For this purpose, the punching device 14 can be moved by a drive unit, for example in the form of a ball screw drive 18 driven by an electric motor, along a vertical punching axis from a starting position into a punching position and vice versa. Furthermore, a damping system referred to in its entirety as 20 may be provided to help prevent overloading the ball screw drive 18 during the punching operation. In addition, the separating device is characterised by a column guide of a machine stand 24 for the movable parts of the separating device. Corresponding separating or punching devices are known in the prior art, for example as described in detail in DE 10 2008 011 772 A1 or DE 10 2007 040 472 A1, with the result that no further detail will be provided on this subject at this juncture.

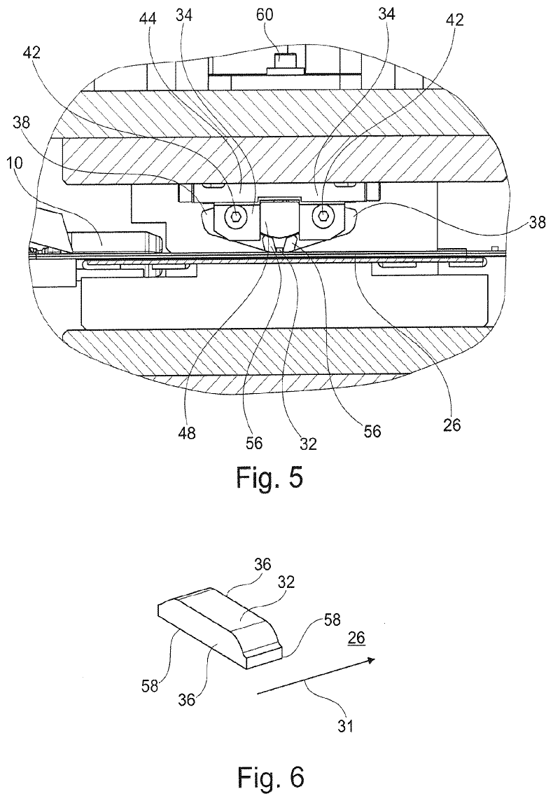

The frame structure 12 with the container products 10 arranged in rows comprises, when viewed in the longitudinal direction, side strips 26, 28, only the front side strips 26 being shown as viewed on FIG. 1. As viewed on the figures, the frame structure 12 with the side strips 26, 28 is in any case transported from left to right in an accordingly horizontal transport direction 31 by means of a conveying device 30. As explained below in further detail, the conveying device 30 acts on positioning aids 32, which are arranged at discrete intervals from one another on the upper side of the side strip 26 as an integral part thereof. It is possible to arrange the positioning aids 32 evenly on both side strips 26, 28 in order to then cause the frame structure 12 with the containers 10 to be transported accordingly on both sides by means of the conveying device 30; in this case, for the sake of simplicity, only the transport movement for the front side strips 26 is shown; however, the same applies to the other side strips 28 as required. As is also shown in FIGS. 1 and 5, a positioning aid 32 arranged on the side strip 26 is in any case fixed in a clamping manner by means of a centring device 34 before carrying out separation of the respective container products 10 from the frame structure 12 leaving behind the waste frame 16. As such, the punching or separating tools of the punching device 14 are aligned in a defined manner opposite the frame structure 12 with the container products 10, which allows a clean separating or cutting operation along predefinable cutting lines without any fear that the container products 10 might be damaged by inaccurate punching.

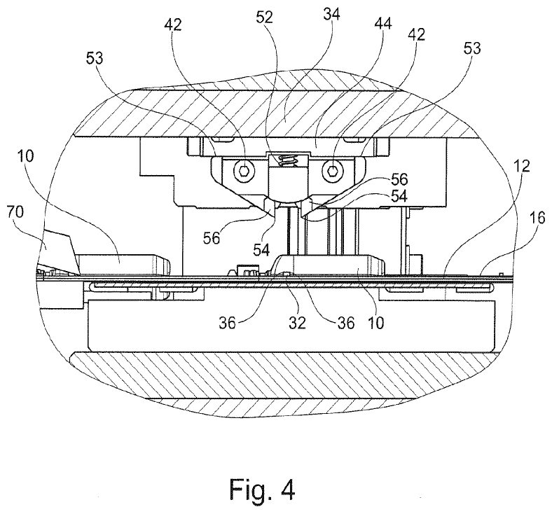

The respective positioning aid 32 is shown in more detail in FIG. 6 and for example consists of a fixing cam, which for example protrudes upwards beyond the side strip 26 as an integral, moulded-on part of said side strip. In this case, the fixing cam is for example designed as a web-like, parallelepipedic fixing rib having two plane-parallel opposite contact surfaces 36 that protrude vertically from the side strip 26. As is also shown in FIGS. 3 to 5, the centring device 34 comprises two movable clamping parts 38, which, viewed in the transport direction 31, in front of and behind the fixing cam to be fixed, act on the two opposite free end contact faces 36 of said fixing cam by applying a clamping force and fixing said cam in a bidirectional manner. In this process, FIGS. 1, 3 and 5 show the centring device 34 in a closed state, whereas FIG. 4 shows an open position.

The clamping parts 38 of the centring device 34 consist of two clamping jaws 40, which are in each case pivotally mounted around a pivot axis 42 on a seat 44 of the centring device 34. As is also shown in FIG. 3, the two clamping jaws 40 are controlled by an actuating device 46 and held in an open position at a predefined distance from one another. This free distance reduces in a clamping position until a clamping gap is reached in which the assignable positioning aid 32 is received in a clearance-free manner with a defined clamping force. In this case, the actuating device 46 comprises a control cam 48 in the form of a pressure piece, which is guided in an axially displaceable manner at least partially along a rod guide 50, and, by means of an energy accumulator in the form of a compression spring 52, which surrounds the rod guide 50, the control cam 48 is pressed downwards, as viewed on FIG. 3, such that the two clamping jaws 40 located in contact with the control cam 48 are pressed in the clockwise and anticlockwise direction respectively, outwards into their open position until they reach a stop 53 (see FIG. 3). If the two clamping jaws 40 are placed with their respective free end 54 pointing conically downwards on the upper side of the side strip 26, these are pressed upwards and then each pivot in opposite directions, as described above, around the respective pivot axis 42. In this process, they also press the spherical control cam 48 upwards. As such, the two opposite clamping jaw ends are in turn pushed towards each other against the compressive force action of the compression spring 52, leading to a clamping or fixing operation for the positioning aid 32, as indicated in FIGS. 1 and 5.

As shown on FIGS. 4 and 5 in particular, the pair of clamping jaws with the two clamping jaws 40 at its free opposite end faces in each case comprises a centring part 56, which comes into linear contact in the clamping position with the positioning aid 32 at its bottom transition 58 to the side strip 56 (see FIG. 6).

The centring device 34 can in particular, by means of a position adjustment in the form of a height adjustment 60, in relation to stationary frame parts 62 of the punching device 14, such as the stationary rod guide 50, for example, be positioned opposite the side strip 26 with its positioning aids 32, in particular, the centring device 34 can be moved accordingly from its non-actuated position as shown in FIG. 4 into the actuated clamping position shown in FIG. 5 and vice versa. A compressive force can also be exerted on the side strip 26 by means of the height adjustment 60 via the ‘closed’ clamping jaw pair towards a contact surface, which is not specified in any further detail, of the machine frame such that, even when viewed in the vertical direction, reliable positioning of the frame structure 12 is achieved before carrying out the separating operation.

To ensure that the respective positioning aid 32 of the side strip 26 is able to pass into the clamping access range of the centring device 34, the side strip 26 and thus the associated frame structure 12 with the container products 10, must first be moved from left to right, as viewed on the figures, along the transport direction 31. The conveying device 30, which comprises a pivotable pawl arrangement 64, is used for this purpose. The pawl arrangement 64 in its entirety is fitted to a conveying carriage 66 of the conveying device 30, which can be moved backwards and forwards in the conventional manner by means of a linear drive 68, wherein, as shown in FIGS. 1 and 2, the conveying carriage 66 is in its foremost transport position together with the pawl arrangement 64. The pawl arrangement 64 comprises a drive pawl 70 which can be pivoted around a pivot axis 72 (see FIG. 1), and which, as viewed in FIGS. 1 and 4, is in its lowered position in which its foremost pick-up point lies loosely on the upper side of the side strip 26.

If, as shown in FIG. 1, one of the positioning aids 32 is fixed in a stationary manner by means of the centring device 34, the conveying carriage 66 along with the pawl arrangement 64 returns from right to left as viewed on FIG. 1 until the pivotable drive pawl 70 passes over the first positioning aid 32 in the row. In this process, the tip of the drive pawl 70 passes over the upper side of the positioning aid 32 (see FIG. 6) and the pawl 70 then drops, due to gravity, viewed in the clockwise direction, along the front contact surface 36 and back onto the upper side of the side strip 26, while the tip of the pawl 70 is simultaneously in linear contact with the bottom transition 58 of the positioning aid 32. In the corresponding position of the drive pawl 70, which equates to pre-positioning for the positioning aid 32, the clamping jaws 40 open and the centring device 34 passes from its clamping position as shown on FIGS. 1 and 5 into its open position according to FIG. 4.

Then, in turn, the linear drive 68 is actuated and the conveying carriage 66 moves together with the pawl arrangement 64 into the foremost transport position illustrated in FIGS. 1 and 5. In this case, the leading positioning aid 32 picked up by means of the pawl arrangement 64 is moved to the centring position beneath the centring device 34 and the centring device 34 can in turn be moved from its starting position as shown in FIG. 4 into the centring position shown in FIG. 5.

The transport sequence by means of the pawl arrangement 64 must therefore always be controlled such that a positioning aid 32 is fixed by the centring device 34; a positioning aid 32 is waiting in a front position for onwards transport to the centring device 34 and the next positioning aid in the row is picked up by the drive pawl 64 to ensure onwards transport to the centring device 34 as soon as the latter has released the previously centred positioning aid 32 again on completion of the separating or punching operation. Overall, the operation is controlled such that the pawl arrangement 64 always provides a kind of pre-positioning for the frame structure 12 and the centring device 34 provides the main centring action as part of the separating or punching operation. It is clear that the pawl arrangement 64 does not necessarily have to act on a positioning aid 32 in the row; it is also possible to allow the drive pawl 70 to drop into an extra recess provided for this purpose in the side strip 26 so as to guarantee that the side strips 26 will be picked up accordingly along the transport direction 31. As such, another distance dimension could then be selected between the pawl arrangement 64 and the centring device 34 if necessary without the need to consider a positioning aid 32 located in the waiting position therebetween.

As part of the separating or punching operation, it has been shown to be beneficial to in each case use at least the cam-like positioning aid 32 for precision positioning by means of the centring device 34, this being less than 30 mm, for example less than 20 mm, for example less than 15 mm from the respective separation of the separating line by means of the punching tool. To ensure a particularly stable fixing operation in this case, it is beneficial to mould the cam-like positioning aid 32 such that it is as rigid as possible in the operating or transport direction 31, for example with sharp-edged transitions, in particular in the bottom transition region 58, in order to allow precise engagement with the pawl arrangement 64 along with the positioning aid for the assigned centring part 56 for the respective clamping jaw 40.

In some embodiments, which are not explained in further detail, the positioning aid 32 can be designed as a perforation or depression in the side strip 26. For this purpose, centring devices 34 and/or centring parts 56 that are accordingly adapted in terms of their geometry should be used.

The disclosure also relates to a positioning device for positioning a frame structure 12 made from plastics material before processing thereof. Such processing may, in addition to the aforementioned separation, also include work steps such as printing, inspecting, marking, labelling, measuring, disinfecting and/or applying a defined breaking point. Combining a plurality of such processing steps is also possible. In any event, during these processing steps, the frame structure 12 is held securely in position by means of the centring device 34.

The processing method to be carried out with the separating and positioning device is characterised in that, in a two-stage conveying and positioning operation along the transport direction 31 by means of the conveying device 30 along with the pawl arrangement 64, pre-positioning takes place by feeding a frame structure 12, with and without container products 10, and a more accurate precision positioning operation than the aforementioned operation is carried out by means of the centring device 34. This therefore has no parallel in the prior art.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “red” or “having advantages” over other embodiments. The term “in particular” and used “particularly” throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-11. (canceled)

12. A separating device for separating individual or multiple container products from a frame structure which is made from plastics material and comprises at least one side strip which can be moved along a transport direction using a conveying device which acts on individual positioning aids of the side strip, wherein at least one positioning aid is fixed in a clamping manner using a centring device before separation is carried out.

13. The separating device of claim 12, wherein the respective positioning aid consists of a fixing cam, wherein the centring device acts on said fixing cam using movable clamping parts in front of and behind the fixing cam to be fixed, as viewed in the transport direction, by applying a clamping force.

14. The separating device of claim 13, wherein the clamping parts of the centring device consist of two clamping jaws, which are controlled by an actuating device and assume a predefinable distance from one another in an open position, said distance reducing in a clamping position until a clamping gap is reached in which the assignable positioning aid is received.

15. The separating device of claim 14, wherein the clamping jaws are mounted in pairs such that they can pivot in a seat of the centring device and wherein a pressure piece arranged between the clamping jaws acts as an actuating device, said pressure piece maintaining the clamping jaws in an inactive position to keep said clamping jaws in an open position by means of an energy accumulator.

16. The separating device of claim 14, wherein the pair of clamping jaws comprises a centring part at each of its opposite free end faces, said centring part coming into linear contact in the clamping position with the positioning aid at its bottom transition to the side strip.

17. The separating device of claim 12, wherein the centring device can be positioned, using a position adjustment in relation to frame parts of the punching device opposite the side strip with its positioning aids.

18. The separating device of claim 12, wherein the conveying device comprises a pivotable pawl arrangement, which, when in a pick-up point in contact with a positioning aid of the side strip, picks up said side strip in the transport direction using an actuator and then can be returned to a starting position to pick up a next positioning aid in the row after moving over said positioning aid into the pick-up position.

19. The separating device of claim 12, wherein pre-positioning takes place using the conveying device and precision positioning of the frame structure using the positioning aids takes place using the centring device.

20. A positioning device for positioning a frame structure made from plastics material, which comprises at least one container product for use in a printing device, an inspection device, a marking device, a measuring device, a disinfection or sterilisation device, wherein individual positioning aids of the frame structure can be fixed in a clamping manner using a centring device between parts of this centring device.

21. A method for operating a processing device, comprising, in a two-stage conveying and positioning operation along a transport direction using a conveying device, pre-positioning by feeding a frame structure comprising container products using a centring device for enabling a more accurate positioning before a separation of the container products is carried out.

22. A method for operating a separating device, wherein at least a cam-like positioning aid is used for precision positioning using a centring device, which cam-like positioning aid being less than 30 mm from the end of the separating line.

23. The separating device of claim 12, wherein the respective positioning aid consists of a fixing cam, which, as an integral part of the side strip, protrudes over said strip and wherein the centring device acts on said fixing cam using movable clamping parts in front of and behind the fixing cam to be fixed, as viewed in the transport direction, by applying a clamping force.

24. The separating device of claim 15, wherein the pair of clamping jaws comprises a centring part at each of its opposite free end faces, said centring part coming into linear contact in the clamping position with the positioning aid at its bottom transition to the side strip.

25. The separating device of claim 17, wherein the position adjustment is in the form of a height adjustment.

26. The separating device of claim 13, wherein the centring device can be positioned, using a position adjustment in relation to frame parts of the punching device opposite the side strip with its positioning aids.

27. The separating device of claim 14, wherein the centring device can be positioned, using a position adjustment in relation to frame parts of the punching device opposite the side strip with its positioning aids.

28. The separating device of claim 15, wherein the centring device can be positioned, using a position adjustment in relation to frame parts of the punching device opposite the side strip with its positioning aids.

29. The separating device of claim 16, wherein the centring device can be positioned, using a position adjustment in relation to frame parts of the punching device opposite the side strip with its positioning aids.

30. The separating device of claim 13, wherein the conveying device comprises a pivotable pawl arrangement, which, when in a pick-up point in contact with a positioning aid of the side strip, picks up said side strip in the transport direction using an actuator and then can be returned to a starting position to pick up a next positioning aid in the row after moving over said positioning aid into the pick-up position.

31. The positioning device of claim 20, wherein the container product is filled and the disinfection or sterilisation device is arranged in a separating device.
